(19) United States
(12) Patent Application Publication
(10) Pub. No.: US 2026/0057117 A1
(43) Pub. Date: Feb. 26, 2026

(54) SYSTEM AND METHOD FOR PERFORMANCE OPTIMIZATION OF STANDARDS-COMPLIANT DATA SANITIZATION OF INFORMATION STORAGE MEDIA

(71) Applicant: Revert Inc., Louisville, CO (US)

(72) Inventors: Jeffrey Majors, Las Vegas, NV (US); Jeremy Valdes, Chicago, IL (US); Glenn Ronald Jacobsen, Arvada, CO (US)

(21) Appl. No.: 19/100,162

(22) PCT Filed: Aug. 1, 2023
(86) PCT No.: PCT/US23/71465

§ 371 Date: Jan. 31, 2025

Related U.S. Application Data
(60) Provisional application No. 63/394,947, filed on Aug. 3, 2022.

(51) Int. Cl. G06F 21/78; G06F 21/57

(52) U.S. Cl. CPC G06F 21/78; G06F 21/575; G06F 2221/2143

(57) ABSTRACT

A system and method for performing standards-compliant data sanitization of Small Computer System Interface (SCSI), Advanced Technology Attachment (ATA), and Non-Volatile Memory Express (NVMe) hard disk drives (HDDs), solid state drives (SSDs), Non-Volatile Memory Express (NVMe) drives, and other portable storage media, e.g. flash storage, USB thumb drives at an optimized speed. The sanitization and overwrite processes herein disclosed are executed by completely web-based applications that use the local hard drive (host) as a server intermediate the web browser and the program files.

### CROSS REFERENCE TO RELATED APPLICATIONS

This application claims the benefit of U.S. Provisional Ser. No. 63/394,947 filed Aug. 3, 2022, the entire disclosure of which is incorporated herein by reference.

### FIELD OF THE INVENTION

The present invention relates generally to the sanitization of information storage media. More specifically, the present invention relates to the sanitization of personal and/or confidential information and data stored on memory devices used on equipment such as laptops, desktops, servers, disk arrays, virtual tape systems and the like. Specifically, the present invention relates to systems and methods for performing standards-compliant data sanitization of information and data storage devices in compliance with standards set by Small Computer System Interface (SCSI) or Advanced Technology Attachment (ATA), and Non-Volatile Memory Express (NVMe), as applicable, e.g. hard disk drives (HDD), solid state drives (SSD), NVMe drives, flash storage, USB thumb drives at an optimized speed.

### BACKGROUND OF THE INVENTION

Data sanitization of information storage media is required to prevent unauthorized access to personal and/or confidential data stored on media such as disk drives and other types of storage devices noted above. Storage devices are typically installed in information and data processing equipment (e.g. servers, disk arrays) that may be sold or on loan or provided to the end user pursuant to the provisions of an expiring lease. Unless the lease is renewed, the equipment must be removed from the lessee's facility and returned to the lessor. The equipment and/or disk drives may be leased to a different customer or resold in a secondary market. Disk drives that have failed are normally returned to the equipment vendor for warranty credit. Moreover, in situations where a data processing equipment user may be undergoing an internal restructuring or reorganization that requires reassignment of data processing assets internally, due to the high cost of data storage media, the information and data residing on reassigned and/or relocated data storage media is sanitized before the data processing equipment is brought into service by the new user.

Data sanitization processes, also known as data eradication, data wiping or data erasure, are software-based processes that, depending on the storage media: (1) overwrite stored data with a zero or a one in several alternating passes which are intended to render the stored data unreadable and unrecoverable; or (2) electronically reset stored data to a factory default value, typically zero. The parameters of a data sanitization process may be dictated by one or more of the many different government and industry standards that may apply to any given situation. As one would expect, the standards differ, for example in requirements for the number of overwrite passes, the overwrite pattern, the randomness of the pattern, and so forth. Moreover, the parameters are dictated by the type of device being sanitized and vary depending upon the specific device. For example, the approach and methodology needed to completely sanitize a hard disk drive (HDD) will differ from those needed to completely sanitize a solid state drive (SSD). There is also a dependence on what data sanitization tools are supported by the storage media, as vendors and manufacturers can enable or disable a tool as they deem fit, e.g. storage media firmware, controller cards.

Over twenty internationally-recognized standards for data sanitization have been published. Some are obsolete; others are too cumbersome to use, an unfortunate situation that creates issues for under-educated users that are simply trying to ensure that stored data has been rendered inaccessible on their disk drives to prevent a data breach. A data breach occurs when personal and/or confidential data is compromised by loss of organizational control or unauthorized access. In 2021, the Ponemon Institute reports that data breach costs rose from US$3.86M to US$4.24M. Clearly then, a data sanitization software user must have the option to select an erasure process from the number of processes available and have supporting documentation and sufficient personal experience to make the correct assessment and selection. A mistake may result in considerable financial loss to the user of the storage media and its customers.

Based on the foregoing, one realizes that data sanitization is a process that typically ends up being a cost-center for an organization. It is largely considered a “necessary evil” in order to comply with data privacy laws and regulations and is costly and time-consuming. Companies are forced to allocate resources and equipment to perform the tasks to avoid costly liability in the event private data is leaked. A company faced with an information and data sanitization task wants a system that is easy to use. However, current state of the art processes require that it license a commercial off the shelf (COTS) application that is not intuitive, is difficult to use, and may result in a data breach or significant loss of money (either through software failure, operational expenses or residual value recovery). Moreover, no one offering is capable of delivering a comprehensive, holistic solution to performing standards-compliant data sanitization across the entirety of the above-referenced storage types, which increases the risk of having an unintentional data breach. For example, one application can only work on one storage device manufacturer's offerings; another application cannot support high-capacity HDDs; and another cannot sanitize SSDs.

In view of the foregoing, it will be apparent to those skilled in the art from this disclosure that a need exists for a comprehensive, easy to use, holistic solution to performing standards-compliant data sanitization across all types of HDD, SSD, NVMe, and other portable storage media and that automates the determination of the most efficient method to execute this sanitization. The present invention addresses these needs in the art as well as other needs, all of which will become apparent to those skilled in the art from the accompanying disclosure.

### SUMMARY OF THE INVENTION

In order to address the aforementioned needs in the art, an information and data sanitation software system and associated methodology are provided which may be adapted to sanitize data stored on all types of HDD, SSD, NVMe, and other portable storage media and which protects the end user from a data breach while maximizing the residual value recovery for an end user.

The system and methodology of the present invention provide the ability to process a wide variety of disk drives simultaneously in parallel, while maximizing throughput and the number of disk drives that can be processed at any given period of time.

In an embodiment, the system and methodology of the present invention include support for high-capacity disk drives.

In another embodiment, the system and methodology execute processes that enable faster processing times and leverage a disk drive's onboard data sanitization capabilities to the extent such capabilities are available and supported.

In an embodiment, the system and methodology use built-in application intelligence and a dynamic decision-tree approach that automatically chooses the most efficient, effective process to sanitize a disk drive in compliance with industry-recognized, published data sanitization standards without requiring the user to make decisions.

In yet another embodiment, the system and methodology leverage their ability to incorporate changing and new disk drive technologies.

In still another embodiment, the system and methodology attempt to identify and sanitize all bad or remapped sectors of the disk drive in the storage device sanitization process.

In another embodiment, the system and methodology include optimization processes that execute code that will dynamically measure the speed of writing and adjust the writing speed using a known algorithm in Python programing language to provide an optimal speed and thereafter adjust the sanitization process for the optimal speed prior to processing a device.

In yet another embodiment, the system and methodology provide a significant reduction in operational expense (labor) and a higher probability of maximizing the residual value recovery of the return/sale of sanitized disk drives and associated equipment.

In another embodiment, the system and methodology is an entirely web-based system that maximizes the processing capabilities of the local host associated with the storage device being sanitized.

These and other features, aspects and advantages of the present invention will become apparent to those skilled in the art from the following detailed description of preferred embodiments taken in connection with the accompanying flow diagrams, which are briefly summarized below, and by reference to the appended claims.

### BRIEF DESCRIPTION OF THE DRAWINGS

Referring now to the attached drawing sheets which form a part of this original disclosure:

FIG. 1A is a flow diagram of a series of preparatory steps and initial process steps initiating a method for performing standards-compliant data sanitization of information and data storage media in accordance with an embodiment;

FIG. 1B is a continuation of the flow diagram of the process steps depicted in FIG. 1A;

FIG. 1C is a continuation of the flow diagram of the process steps depicted in FIGS. 1A and 1B showing the iterative and final steps of the method for performing standards-compliant data sanitization of information and data storage media in accordance with an embodiment; and

FIG. 2 is a flow diagram of the process steps in a method for optimizing the speed of overwriting information and data residing on storage media in accordance with an embodiment.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

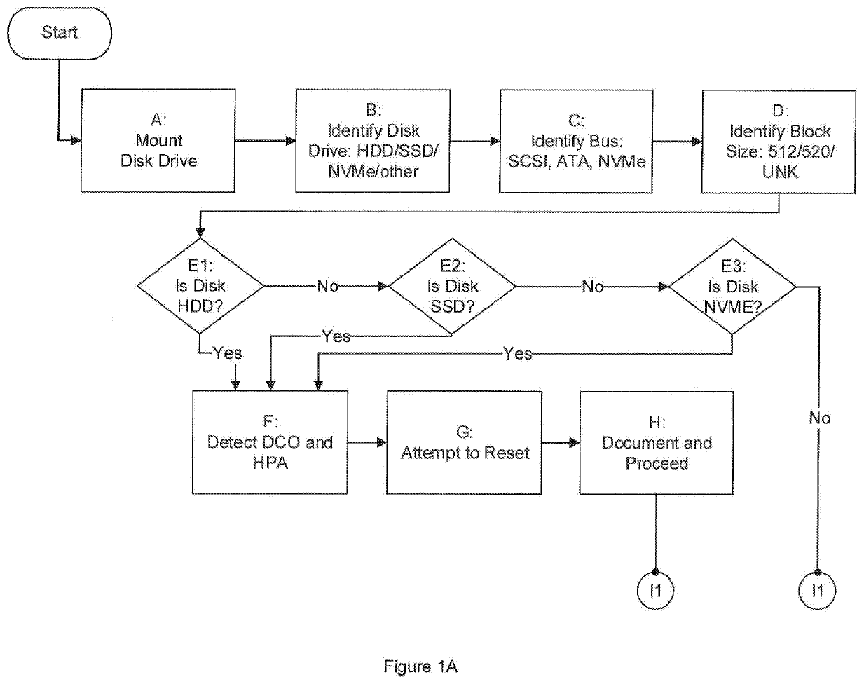

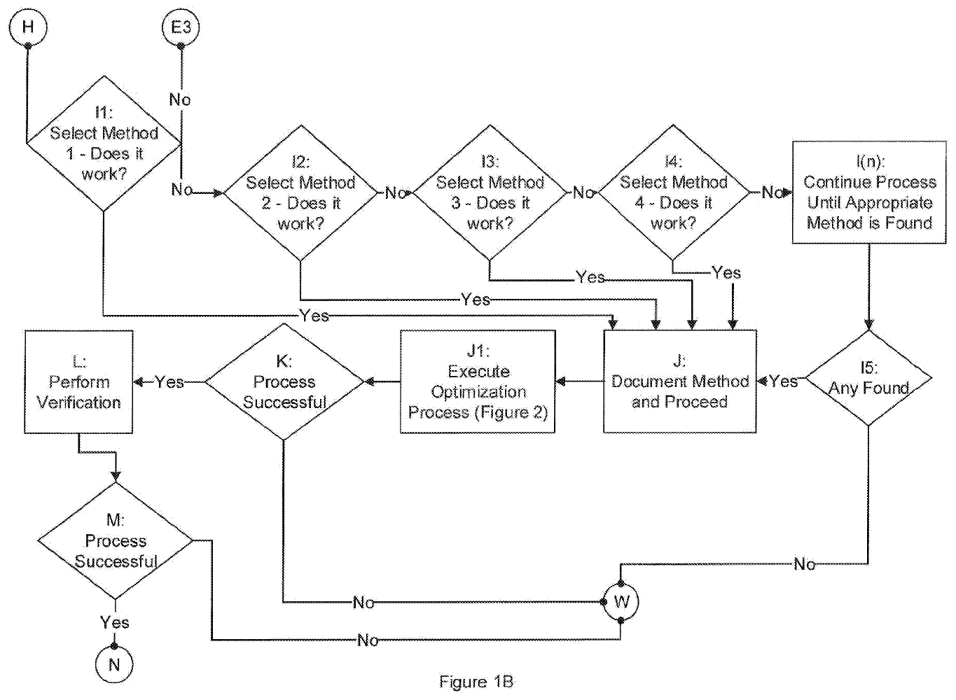

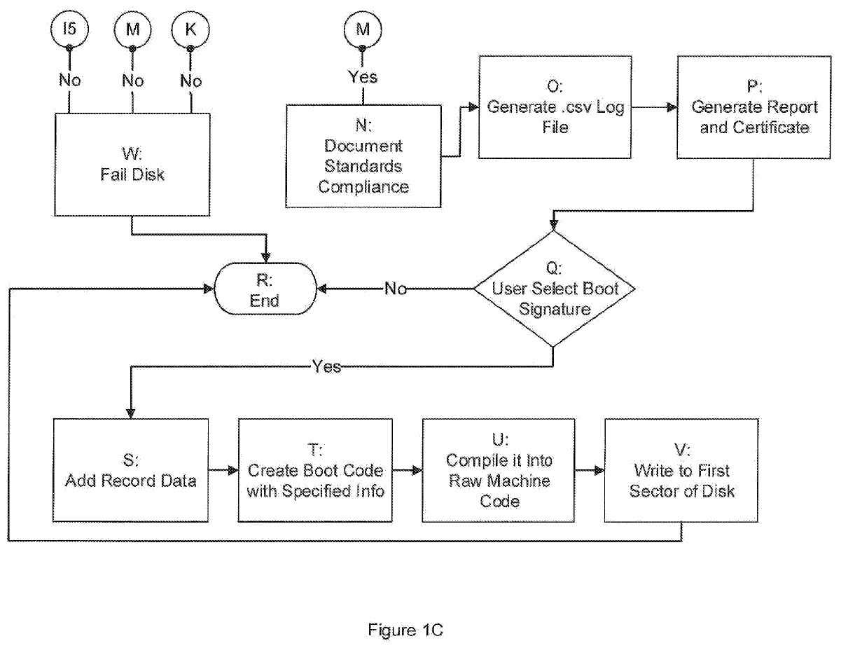

Referring initially to FIG. 1A, a series of preparatory steps, Steps A-D, are required to be taken before the information and data sanitization process of the instant invention, which may also be referred to herein as an erasure or an overwrite process, may be initiated. The initial preparatory step is Step A, the step of mounting disk drives, either individually or within a system. “Mounting” is a term of art which refers to the process of operatively connecting or otherwise making the storage device accessible to the computer or data processing system so that files stored thereon may be recognized and used by the data processing system for data storage and retrieval. The storage device may be integral with the computer system or may be a separate, removable device such as a removable hard drive, a thumb or stick drive, and the like. After the storage device is mounted, its type must be identified, be it a hard disk drive (HDD), solid state drive (SSD), Non-Volatile Memory Express drive (NVMe), or other portable storage media. The identification process is performed at Step B. The next step, Step C, is the identification of the bus structure of the system, which is the shared transmission medium of the system components controlling the access to and use of system data, the standards, and the various operating commands associated with the system operation. This step is crucial to the identification of the applicable data sanitization standards which dictate the parameters of the sanitization process to ensure that the sanitization process is in compliance with the applicable standards. Finally, at Step D, the number of bytes in each data block or cache (sized or configured in preselected number of bytes) is identified, which will be used to optimize the speed and efficiency of sanitization procedures applicable to sanitize any given storage medium.

The next step, Step E1, initiates the sanitization process via identification of the type of storage medium or media that is/are undergoing sanitization via a series of iterative queries, e.g. -HDD (Step E1), SDD (Step E2), NVMe (Step E3), or some other type. For purposes of illustration, the steps shown in FIG. 1A are identified as being performed on a device identified in Step B as a hard disk drive, HDD. However, the same steps and process flow illustrated in FIG. 1A is applicable if the device is identified in Step B as a solid state drive (SSD) (Step E2), Non-Volatile Memory Express drive (NVMe) (Step E3), or other portable storage media. Once the type of storage medium is identified, the next step, Step F, involves the identification of the Dynamic Configuration Overlay (DCO), which allows access to the embedded software in open source situations and/or the Host Protected Area (HPA) which is a means of identifying and addressing addressable space on a hard drive. If either are detected, then at Step G, an attempt is made to reset either or both to provide access. If the attempts fail, the actions are documented at Step H.

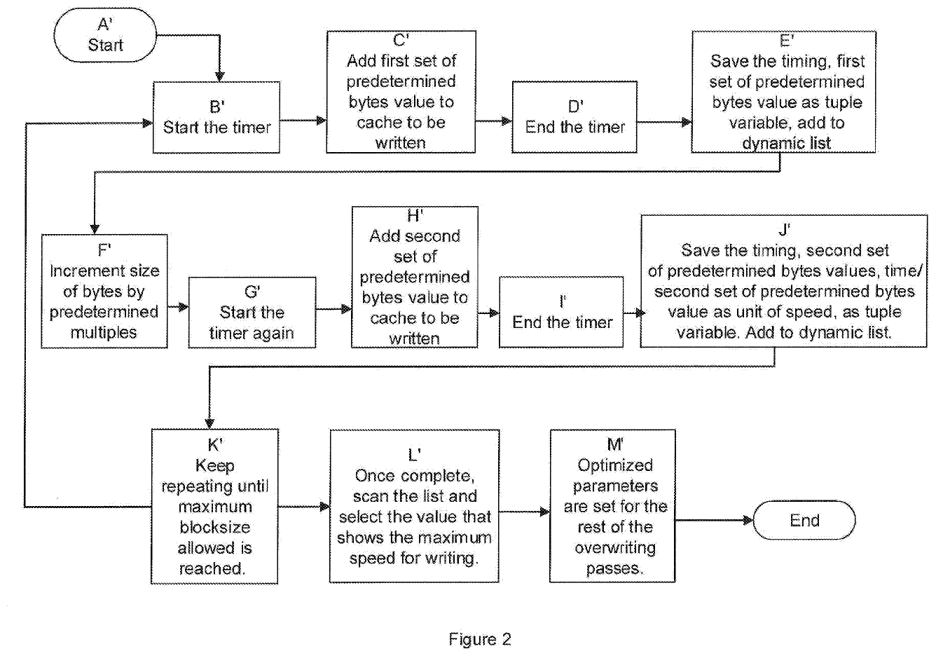

Referring now to FIG. 1B, a first data sanitization method (Method 1) for sanitizing the storage medium is then selected, applied, and evaluated for useability in the application at Step I₁. The results are documented at Step J, and an overwriting speed optimization process is applied, as hereinbelow described in greater detail and illustrated in FIG. 2. If the application of Method 1 and the optimization process results in the completion of a successful sanitization which is evaluated at Step K, the process flow progresses to a verification step, Step L. If the sanitation is verified as successful at Step L, process output documents are generated and undergo a Document Standards Compliance review at Step N, as seen in FIG. 1C. Thereafter, a comma-separated values log file (.csv file) is generated at Step O followed by the generation of a Final Report and a Certificate certifying successful completion of the overwrite process at Step P. The end user then may select or decline to enable a boot signature at Step Q, at which point the process proceeds either to closure at Step R or, alternatively, moves to Step S where the record data of the process is added to the Final Report followed by creation of a boot code at Step T using information selected before the sanitation process is started. The process record data is the report ID that binds the digital signature to the report documentation. The preselected information includes: the date of sanitation, sanitation time, the system serial number (if applicable), the sanitization software including the version used, the sanitization method, the drive serial number, and the report ID. The information is then complied into raw machine code comprising 512 bytes at Step U and all 512 bytes are written onto a first boot sector of the disk at Step V, thus completing the process, again at Step R.

Returning now to Steps K and M in FIG. 1B, completion evaluation and verification of a sanitization procedure using a pre-selected Method, in this instance, Method 1, should either the completion evaluation step or the verification step result in a failure, the disk drive is designated as a “Failed Disk” and documented with the failure details at Step W. The process using Method 1 is deemed to not have worked, and thereafter is terminated at Step R.

Referring now to Step I2, a second method, Method 2, is selected, and the process steps defined above are repeated either resulting in a verified sanitization success or a failure. If another failure is experienced, a third method, Method 3 is selected at Step I3, and again, the process steps as hereinabove set forth are performed. This iteration is repeated at Step I(n) until a successful verified data sanitization of the stored information and data is achieved or the operator determines that none will be successful, which is represented by way of example and not of limitation at Step I5. However, it is to be understood that the number of iterations, n, needed until a successful sanitization is achieved or a point is reached where the operator determines that none will be successful will depend upon the circumstances of the specific sanitization process and device being sanitized. The storage medium is then designated as a “Failed Disk” and documented with the failure details at Step W. The process using the next selected method is deemed to not have worked, and thereafter is terminated at Step R.

Disk performance is dependent on many factors. A disk writes data in blocks in as little as 512 bytes up to 4096 bytes at a time. Enterprise disks often are formatted with metadata adding more size to a given block, for example, 520 bytes as opposed to 512 bytes. The performance of an overwrite sanitization process is often dismal when writing 512 bytes at a time due to the fact that if a block or cache size is set to 512 bytes with a system total of one million blocks, the process requires “seeking access” to every block. By defining the block or cache size in terms of a larger number of bytes thereby creating bigger blocks, less process time is required to seek access and more time is available to start overwriting over the entire data block. However, an upper limit to block size does exist. As the disk cache fills up, the performance starts to degrade as the time to complete an overwrite increases significantly in proportion to the time required to overwrite the previous block size. Once this limit has been attained, the overwrite parameters are deemed to be optimized and are set for the remainder of the sanitization process.

Referring now to FIG. 2, a flow diagram of the overwriting speed optimization process or module (Step J1 in FIG. 1B) is depicted. Beginning at the start of the process, Step A′, the initial operation step, Step B′, consists of starting a timer. At Step C′, a first cache having a first predetermined byte size to be written is submitted. Upon completion of the overwrite of the first cache, the timer is turned off at Step D′, and the elapsed time and the size of the first set of predetermined bytes is saved as the tuple variable and added to a dynamic list at Step E′. At Step F′, the cache size is increased incrementally by predetermining a multiple increase in the number of bytes per cache. For example, if the number of bytes in a cache is increased by a multiple of eight (8), the next cache to be overwritten would contain 4096 bytes. At Step G′ the timer is restarted and at Step H′, the second set of a predetermined number of bytes to the cache, and the overwrite time is recorded. The timer is stopped at Step I′. At Step J′, the timing, the size of the second set of predetermined bytes, and the time per second to overwrite the second set of predetermined bytes as unit of speed are saved as the tuple variable and added to the dynamic list. The iterative process is repeated at Step K′ until a maximum block or cache size is determined, which will be indicated by an incremental decrease in processing speed at a next iteration, as noted by a scan of the dynamic list of values at Step L′. At Step M′, the optimized parameters for the overwrite process are set and are used to complete the sanitization of the storage medium. The verification and documentation steps set forth above with respect to the process disclosed in FIGS. 1A-1C are applied to complete the overall process.

Programmatically, the novel processes of the present invention are invoked though an easy-to-use graphical user interface (GUI) that executes program files that are transcribed into a language that only a web browser can read. Thereafter, it initiates a process to select the most efficient, effective method of data sanitization based on the disk drive's unique properties, e.g. SCSI, ATA, or NVMe; HDD, SSD, NVMe, supported sanitization method(s). As the data sanitization process proceeds, the software dynamically recalculates its speed of processing and automatically adjusts to optimize throughput. The sanitization and overwrite processes herein disclosed are completely web-based applications that use the local hard drive (host) as a server intermediate the web browser and the program files.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A method for performing data sanitization of information and data residing on a storage medium or storage media operatively connected to a computer or data processing system in compliance with published industry standards, the storage medium or storage media having a Dynamic Configuration Overlay (DCO), embedded software in open source situations and/or a Host Protected Area (HPA), and information and data stored in data blocks or caches of a predetermined byte size, the computer or data processing system including a bus structure, the method comprising the steps of: preparing the computer or data processing system and storage medium or media for sanitization of information and data residing thereon, the preparation steps including the steps of;
A. operatively connecting the storage medium or media to the computer or data processing system so that files stored thereon may be recognized and used by the computer or data processing system for data storage and retrieval;
B. querying the type of storage medium or media that is/are undergoing sanitization;
C. identifying the bus structure of the computer or data processing system; and
D. identifying the number of bytes in each data block or cache; initiating the sanitization process, the initiation steps including the steps of;
E1. verifying the type of storage medium or media that is/are undergoing sanitization by querying if the storage medium or media is/are hard disk drive (s);
E2. if the query of Step E1 is negative, is the type of storage medium or media that is/are undergoing sanitization solid state drive(s);
E3. if the query of Step E2 is negative, is the type of storage medium or media that is/are undergoing sanitization Non-Volatile Memory Express drive(s):
F. if the query of any one of Steps E1, E2 or E3 is positive, then identifying the Dynamic Configuration Overlay (DCO) and detecting either the embedded software in open source situations and/or the Host Protected Area (HPA);
G. attempting to reset either the embedded software in open source situations and/or the HPA and accessing the embedded software in open source situations and/or the HPA to sanitize information and data residing thereon;
H. documenting the results of the attempt to reset;

11. selecting and applying a first information and data sanitization method to the storage medium or media undergoing sanitization and evaluating it for useability in the application;
J. documenting and executing the first information and data sanitization method selected in Step I1;
J1 executing a data and information overwriting speed optimization process;
K. evaluating successful completion of the sanitization and routing process flow to step W, failing storage medium or media, if the evaluation indicates unsuccessful sanitization or proceeding to step L if the evaluation indicates successful completion of the sanitization;
L. verifying successful sanitization if the evaluation step, step K, indicates successful sanitization;
M. routing process flow to step W, failing storage medium or media, if the verification step, step L, indicates unsuccessful sanitization or proceeding to step N if the verification step, step L, indicates successful verification;
N. generating process output documents and reviewing for Document Standards Compliance if the verification step, step L, indicates unsuccessful sanitization;
O. generating a comma-separated values log file (.csv file);
P. generating a final report and a certificate certifying successful completion of the sanitization process;
Q. querying an end user of the storage medium or storage media to either select or decline enablement of a boot signature, routing the process flow to step S if the end user selects enablement of a boot signature, or proceeding to step R if the end user declines enablement of a boot signature;
R. terminating the sanitization method selected at Step I1;
S. adding record data of the sanitization process;
T. creating a boot code;
U. compiling the boot code into raw machine code;
V. writing the raw machine code onto a first boot sector of the storage medium or media and routing the process flow to step R; and
W. failing the storage medium or media if the evaluation step, step K, or the verification step, step L, indicates unsuccessful sanitization.

2. The method of claim 1 further including step I2, if the completion evaluation step, step K or the verification step, step M result in a failure of the first information and data sanitization method selected in Step I1, selecting and applying a second information and data sanitization method to the storage medium or media undergoing sanitization and evaluating for useability in the application and repeating steps J through V.

3. The method of claim 2 further including the steps I3, I4, I(n) of reiterating the step of selecting and applying a different information and data sanitization method to the storage medium or media undergoing sanitization and evaluating for useability in the application if the completion evaluation step, step K, or the verification step, step L, result in a failure of the information and data sanitization method selected in the immediately preceding selection step in the iteration or if at step I5 no appropriate method is found.

4. The method of claim 1 wherein the overwriting speed optimization process of step J1 comprises the steps of:
A′. initiating the process;
B′. starting a timer;
C′. adding a first cache having a first predetermined byte size or value to be overwritten and overwriting the cache;
D′. stopping the timer upon completion of the overwrite of the first cache;
E′. saving the elapsed time and the predetermined byte size of the first cache as a tuple variable and adding the elapsed time and the predetermined byte size of the first cache to a dynamic list;
F′. increasing the cache size incrementally by predetermining a multiple increase in the number of bytes per cache;
G′. restarting the timer;
H′. adding the second set of a predetermined byte size or value to the cache to be overwritten and overwriting the cache;
I′. stopping the timer upon completion of the overwrite of the second cache;
J′. saving the elapsed time, the predetermined byte size of the second cache, and the time per second to overwrite the second set of predetermined bytes as unit of speed as the tuple variable and added it to the dynamic list;
K′ repeating the iterative process of steps F′ through J′ until a maximum block or cache size is determined, as indicated by an incremental decrease in processing speed at a next iteration;
L′ scanning the dynamic list of values to determine the value that indicates the maximum overwriting speed; and
M′ fixing the optimum block or cache size and overwriting speed as the optimum parameters for the sanitization process.

5. The method of claim 1 wherein the storage medium or storage media is a hard disk drive (HDD), a solid state drive (SSD), a Non-Volatile Memory Express drive (NVMe), or portable storage media such as a flash storage drive or a USB thumb drive.

6. The method of claim 5 wherein the storage medium or storage media are high capacity storage media.

7. The method of claim 1 wherein the published industry standards include standards set by Small Computer System Interface (SCSI), Advanced Technology Attachment (ATA), or Non-Volatile Memory Express (NVMe) standards setting organizations.

8. A web-based system for performing a method for performing data sanitization of information and data residing on a storage medium or storage media operatively connected to a computer or data processing system in compliance with published industry standards, the storage medium or storage media having a Dynamic Configuration Overlay (DCO), embedded software in open source situations and/or a Host Protected Area (HPA), and information and data stored in data blocks or caches of a predetermined byte size, the computer or data processing system including a bus structure, the method comprising the steps of:
preparing the computer or data processing system and storage medium or media for sanitization of information and data residing thereon, the preparation steps including the steps of;
A. operatively connecting the storage medium or media to the computer or data processing system so that files stored thereon may be recognized and used by the computer or data processing system for data storage and retrieval;
B. querying the type of storage medium or media that is/are undergoing sanitization;
C. identifying the bus structure of the computer or data processing system; and
D. identifying the number of bytes in each data block or cache;
initiating the sanitization process, the initiation steps including the steps of;
E1. verifying the type of storage medium or media that is/are undergoing sanitization by querying if the storage medium or media is/are hard disk drive (s);
E2. if the query of Step E1 is negative, is the type of storage medium or media that is/are undergoing sanitization solid state drive(s);
E3. if the query of Step E2 is negative, is the type of storage medium or media that is/are undergoing sanitization Non-Volatile Memory Express drive(s);
F. if the query of any one of Steps E1, E2 or E3 is positive, then identifying the Dynamic Configuration Overlay (DCO) and detecting either the embedded software in open source situations and/or the Host Protected Area (HPA);
G. attempting to reset either the embedded software in open source situations and/or the HPA and accessing the embedded software in open source situations and/or the HPA to sanitize information and data residing thereon;
H. documenting the results of the attempt to reset;

11. selecting and applying a first information and data sanitization method to the storage medium or media undergoing sanitization and evaluating it for useability in the application;
J. documenting and executing the first information and data sanitization method selected in Step I1;
J1 executing a data and information overwriting speed optimization process;
K. evaluating successful completion of the sanitization and routing process flow to step W, failing storage medium or media, if the evaluation indicates unsuccessful sanitization or proceeding to step L if the evaluation indicates successful completion of the sanitization;
L. verifying successful sanitization if the evaluation step, step K, indicates successful sanitization;
M. routing process flow to step W, failing storage medium or media, if the verification step, step L, indicates unsuccessful sanitization or proceeding to step N if the verification step, step L, indicates successful verification;
N. generating process output documents and reviewing for Document Standards Compliance if the verification step, step L, indicates unsuccessful sanitization;
O. generating a comma-separated values log file (.csv file);
P. generating a final report and a certificate certifying successful completion of the sanitization process;
Q. querying an end user of the storage medium or storage media to either select or decline enablement of a boot signature, routing the process flow to step S if the end user selects enablement of a boot signature, or proceeding to step R if the end user declines enablement of a boot signature;
R. terminating the sanitization method selected at Step I1;
S. adding record data of the sanitization process;
T. creating a boot code;
U. compiling the boot code into raw machine code;
V. writing the raw machine code onto a first boot sector of the storage medium or media and routing the process flow to step R; and
W. failing the storage medium or media if the evaluation step, step K, or the verification step, step L, indicates unsuccessful sanitization.

9. The web-based system of claim 9 further including a graphical user interface (GUI) adapted to execute program files that only a web browser can read.

10. The web-based system of claim 9 further including a local storage medium adapted as a server and operatively connected intermediate the web browser and the program files.

11. The web-based system of claim 10 wherein the method further includes step I2, if the completion evaluation step, step K or the verification step, step M result in a failure of the first information and data sanitization method selected in Step I1, selecting and applying a second information and data sanitization method to the storage medium or media undergoing sanitization and evaluating for useability in the application and repeating steps J through V.

12. The web-based system of claim 11 wherein the method further includes the steps I3, I4, I(n) of reiterating the step of selecting and applying a different information and data sanitization method to the storage medium or media undergoing sanitization and evaluating for useability in the application if the completion evaluation step, step K, or the verification step, step L, result in a failure of the information and data sanitization method selected in the immediately preceding selection step in the iteration or if at step I5 no appropriate method is found.

13. The web-based system of claim 12 wherein the overwriting speed optimization process of step J1 of the method comprises the steps of:
A′. initiating the process;
B′. starting a timer;
C′. adding a first cache having a first predetermined byte size or value to be overwritten and overwriting the cache;
D′. stopping the timer upon completion of the overwrite of the first cache;
E′. saving the elapsed time and the predetermined byte size of the first cache as a tuple variable and adding the elapsed time and the predetermined byte size of the first cache to a dynamic list;
F′. increasing the cache size incrementally by predetermining a multiple increase in the number of bytes per cache;
G′. restarting the timer;
H′. adding the second set of a predetermined byte size or value to the cache to be overwritten and overwriting the cache;
I′. stopping the timer upon completion of the overwrite of the second cache;
J′. saving the elapsed time, the predetermined byte size of the second cache, and the time per second to overwrite the second set of predetermined bytes as unit of speed as the tuple variable and added it to the dynamic list;
K′ repeating the iterative process of steps F′ through J′ until a maximum block or cache size is determined, as indicated by an incremental decrease in processing speed at a next iteration;
L′ scanning the dynamic list of values to determine the value that indicates the maximum overwriting speed; and
M′ fixing the optimum block or cache size and overwriting speed as the optimum parameters for the sanitization process.

14. The web-based system of claim 13 wherein the system is adapted to execute the method for performing data sanitization of information and data residing on a wide variety of storage media in parallel, thereby maximizing throughput and the number of storage media that can be processed at any given period of time.

15. A computer-readable medium storing instructions that, when executed by a computer, cause it to perform a method for performing data sanitization of information and data residing on a storage medium or storage media operatively connected to a computer or data processing system in compliance with published industry standards, the storage medium or storage media having a Dynamic Configuration Overlay (DCO), embedded software in open source situations and/or a Host Protected Area (HPA), and information and data stored in data blocks or caches of a predetermined byte size, the computer or data processing system including a bus structure, the method comprising the steps of:
preparing the computer or data processing system and storage medium or media for sanitization of information and data residing thereon, the preparation steps including the steps of;
A. operatively connecting the storage medium or media to the computer or data processing system so that files stored thereon may be recognized and used by the computer or data processing system for data storage and retrieval;
B. querying the type of storage medium or media that is/are undergoing sanitization;
C. identifying the bus structure of the computer or data processing system; and
D. identifying the number of bytes in each data block or cache;
initiating the sanitization process, the initiation steps including the steps of;
E1. verifying the type of storage medium or media that is/are undergoing sanitization by querying if the storage medium or media is/are hard disk drive (s);
E2. if the query of Step E1 is negative, is the type of storage medium or media that is/are undergoing sanitization solid state drive(s);
E3. if the query of Step E2 is negative, is the type of storage medium or media that is/are undergoing sanitization Non-Volatile Memory Express drive(s);
F. if the query of any one of Steps E1, E2 or E3 is positive, then identifying the Dynamic Configuration Overlay (DCO) and detecting either the embedded software in open source situations and/or the Host Protected Area (HPA);
G. attempting to reset either the embedded software in open source situations and/or the HPA and accessing the embedded software in open source situations and/or the HPA to sanitize information and data residing thereon;
H. documenting the results of the attempt to reset;

11. selecting and applying a first information and data sanitization method to the storage medium or media undergoing sanitization and evaluating it for useability in the application;
J. documenting and executing the first information and data sanitization method selected in Step I1;
J1 executing a data and information overwriting speed optimization process;
K. evaluating successful completion of the sanitization and routing process flow to step W, failing storage medium or media, if the evaluation indicates unsuccessful sanitization or proceeding to step L if the evaluation indicates successful completion of the sanitization;
L. verifying successful sanitization if the evaluation step, step K, indicates successful sanitization;
M. routing process flow to step W, failing storage medium or media, if the verification step, step L, indicates unsuccessful sanitization or proceeding to step N if the verification step, step L, indicates successful verification;
N. generating process output documents and reviewing for Document Standards Compliance if the verification step, step L, indicates unsuccessful sanitization;
O. generating a comma-separated values log file (.csv file);
P. generating a final report and a certificate certifying successful completion of the sanitization process;
Q. querying an end user of the storage medium or storage media to either select or decline enablement of a boot signature, routing the process flow to step S if the end user selects enablement of a boot signature, or proceeding to step R if the end user declines enablement of a boot signature;
R. terminating the sanitization method selected at Step I1;
S. adding record data of the sanitization process;
T. creating a boot code;
U. compiling the boot code into raw machine code;
V. writing the raw machine code onto a first boot sector of the storage medium or media and routing the process flow to step R; and
W. failing the storage medium or media if the evaluation step, step K, or the verification step, step L, indicates unsuccessful sanitization;

16. The computer-readable medium of claim 15 wherein the overwriting speed optimization process of step J1 of the method comprises the steps of:
A′. initiating the process;
B′. starting a timer;
C′. adding a first cache having a first predetermined byte size or value to be overwritten and overwriting the cache;
D′. stopping the timer upon completion of the overwrite of the first cache;
E′. saving the elapsed time and the predetermined byte size of the first cache as a tuple variable and adding the elapsed time and the predetermined byte size of the first cache to a dynamic list;
F′. increasing the cache size incrementally by predetermining a multiple increase in the number of bytes per cache;
G′. restarting the timer;
H′. adding the second set of a predetermined byte size or value to the cache to be overwritten and overwriting the cache;
I′. stopping the timer upon completion of the overwrite of the second cache;
J′. saving the elapsed time, the predetermined byte size of the second cache, and the time per second to overwrite the second set of predetermined bytes as unit of speed as the tuple variable and added it to the dynamic list;
K′ repeating the iterative process of steps F′ through J′ until a maximum block or cache size is determined, as indicated by an incremental decrease in processing speed at a next iteration;
L′ scanning the dynamic list of values to determine the value that indicates the maximum overwriting speed; and
M′ fixing the optimum block or cache size and overwriting speed as the optimum parameters for the sanitization process.

17. The computer-readable medium of claim 16 further adapted to store instructions that, when executed by a computer, cause it to perform the method for performing data sanitization of information and data residing on a wide variety of storage media in parallel, thereby maximizing throughput and the number of storage media that can be processed at any given period of time.
